(19) United States
(12) Patent Application Publication
(10) Pub. No.: US 2011/0211115 A1
(43) Pub. Date: Sep. 1, 2011

(54) MODULAR TELEVISION INPUT

(76) Inventor: Leonard Tsai, Mountain View, CA (US)

(21) Appl. No.: 13/125,971

(22) PCT Filed: Oct. 29, 2008
(86) PCT No.: PCT/US08/81603

§ 371 Date: Apr. 25, 2011

(51) Int. Cl. H04N 7/01

(52) U.S. Cl. 348/441; 348/E07.003

(57) ABSTRACT

A modular signal interface system is provided. An input module 110 can include one or more first interfaces 105 configured to accept a first signal having a first format. The input module 110 can further include one or more converters 305 to convert the first signal to a second signal 130 having a second format. The input module 110 can also include a bi-directional second interface 115 configured to communicate all or a portion of the second signal 130 to a display device 190. The second interface 115 can be communicatively coupled to a bi-directional third interface 150 disposed in, on, or about the display device 190. In one or more embodiments, at least a portion of the second interface 115 can be detachably attached to at least a portion of the third interface 155, thereby permitting the removal and/or replacement of the input module 110.

### BACKGROUND

Video displays must flexibly accommodate an already wide and constantly growing variety of audio, video, and combined audio/visual (“A/V”) signal interfaces. Examples of currently available interfaces include RG-6 and RG-9 coaxial; 4-pin, 7-pin and 9-pin S-video; Y/Pr/Pb component video; composite video; and high-definition multimedia interface (HDMI). Continual advancements and ongoing development of audio/visual (A/V) components, particularly in the field of high-resolution audio and video programming, can result in an array of specialized audio, video, and/or A/V components such as DVD players, cable converters, satellite converters, and home file servers attached to a common, shared, display device.

Unfortunately, with each component potentially having a different type of signal interface, the number of available interfaces on the display device is often exhausted or inadequate to accommodate newly developed interface types. In addition, older, or specialty, audio, video and A/V components may only be equipped with one or more “legacy signal” interfaces which, due to low demand, are not typically provided on commonly available display devices. The need to supply multiple newer audio, video and/or A/V interfaces, and the potential need to supply one or more legacy audio, video, and/or A/V interfaces, all on a single display device can add significant manufacturing complexity and increase costs for a display device having a variety of A/V signal interfaces that will likely remain unused by the vast majority of the consuming public.

There is a need, therefore, for a system providing one or more audio, video or A/V interfaces flexibly accommodating the installation of one or more current, future and legacy audio, video, or A/V interfaces, and permitting flexible signal processing based upon the available audio, video and/or A/V signals and the needs of the consumer.

### SUMMARY

A modular signal interface system is provided. An input module can include one or more first interfaces configured to accept a first signal supplied in a first format. The input module can further include one or more converters to convert the first signal to a second signal having a second format. The input module can also include a bi-directional second interface configured to communicate all or a portion of the second signal to a display device. The second interface can be communicatively coupled to a bi-directional third interface disposed in, on, or about the display device. In one or more embodiments, at least a portion of the second interface can be detachably attached to at least a portion of the third interface, thereby permitting the removal and/or replacement of the input module.

A method for interfacing one or more signals to a display device using one or more input and/or adjustment modules is also provided. One or more input and/or adjustment modules can be bi-directionally communicatively coupled to a display device. The one or more input and/or adjustment modules can include a first interface, a converter, and a bi-directional second interface. A first signal, having a first format can be introduced to the first interface disposed in, on, or about an input module. All or a portion of the first signal can be converted within the input module to provide a second signal having a second format. All or a portion of the second signal can be communicated via the bi-directional second interface to a third interface disposed in, on or about the display device. The display device can convert the second signal to one or more audio and/or visual displays.

As used herein, the term “couple” or “coupled” can refer to any form of electrically conductive or magnetically inductive connection linking two or more devices. The connection can be electrically conductive, for example using one or more conductors such as copper or aluminum wire, conductive strips on a printed circuit board, or the like to connect two or more components. The connection can be magnetically inductive, for example, stimulating the flow of current from a transformer secondary coil by passing a current through a primary coil inductively coupled to the secondary coil. The connection can be electro-magnetic, for example by controlling current flow through a relay contact via an independent relay coil such that passage of a current through the relay coil can magnetically open and close the relay contact.

As used herein, the terms “conduit” and the plural “conduits” can refer to any system or device suitable for sustaining the flow of electrical energy therethrough. In one or more embodiments, the term “conduit” can refer to any wired or wireless means for transmission of electrical energy at any voltage or current. In one or more specific embodiments, the term “conduit” can refer to one or more solid or hollow conductors formed using one or more conductive or superconductive materials, including, but not limited to copper, copper alloys, aluminum, aluminum alloys, nickel, nickel alloys, gold, gold alloys, silver, silver alloys, cuprate-perovskite ceramics (“high temperature superconductors”), or any combination thereof. In one or more embodiments, the term “conduit” can refer to conductors printed or otherwise deposited, layered, soldered, or disposed on single or multi-layer printed circuit boards.

As used herein the term “interface” and the plural “interfaces” can refer to any system, device or combination of systems and/or devices used to promote or otherwise provide electrical communication between two or more devices. As used herein, the term “interface” can refer interchangeably to wired or wireless forms of interconnection. Typical, non-limiting, examples of wired interfaces can include male/female plug connections, terminal strips, terminal blocks, screw terminals, screw connections, jumpers, line splices, and the like. Typical, non-limiting, examples of wireless interfaces can include radio frequency (“RF”) connections, Institute of Electrical and Electronics Engineers (“IEEE”) 802.11(b)(g)(n) wireless local area network (WLAN “WiFi”) connections, cellular connections (e.g. CDMA, GSM, and the like); Bluetooth® connections, and any present or future similar wireless data transmission technologies.

### BRIEF DESCRIPTION OF THE DRAWINGS

Advantages of one or more disclosed embodiments may become apparent upon reading the following detailed description and upon reference to the drawings in which:

FIG. 1 depicts a schematic diagram of an illustrative modular input system, according to one or more embodiments described;

FIG. 2 depicts a schematic diagram of another illustrative modular input system, according to one or more embodiments described;

FIG. 3 depicts an exemplary wired input module, according to one or more embodiments described;

FIG. 4 depicts an exemplary wireless input module, according to one or more embodiments described;

FIG. 5 depicts an exemplary adjustment module, according to one or more embodiments described; and

FIG. 6 depicts an exemplary logic flow diagram for interfacing one or more signals to a display device using one or more input and/or adjustment modules, according to one or more embodiments described.

### DETAILED DESCRIPTION

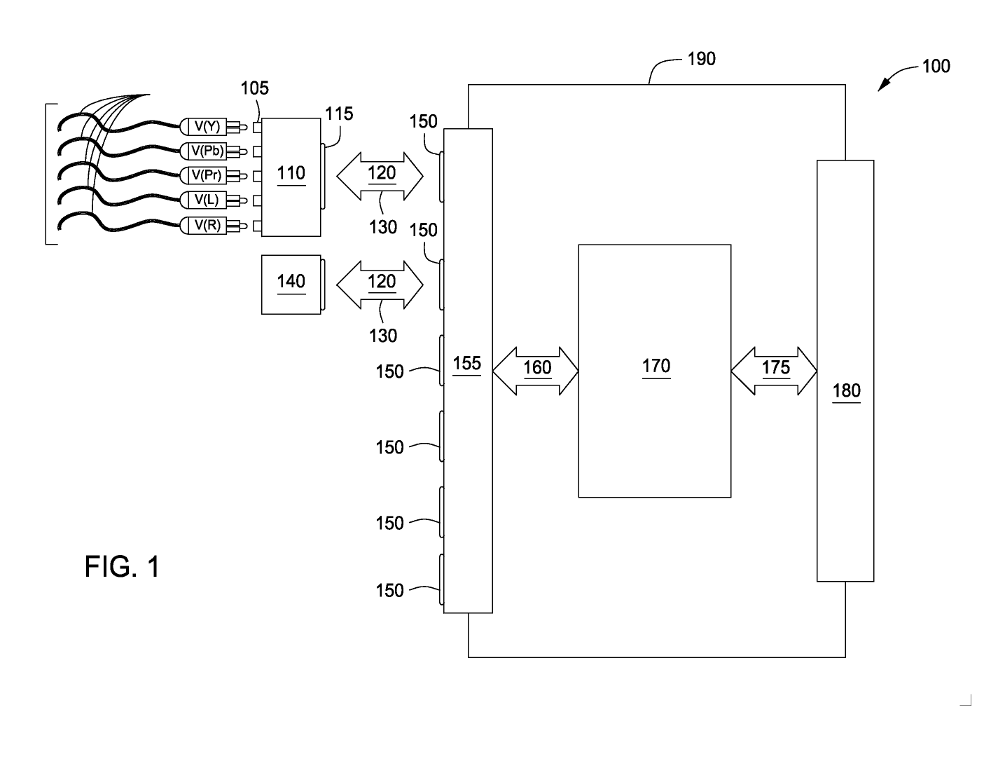

FIG. 1 depicts a schematic diagram of an illustrative modular converter system 100, according to one or more embodiments. In one or more embodiments, the system 100 can include one or more input modules 110, each having one or more first interfaces 105 and one or more second interfaces 115 disposed thereupon. The system 100 can also include one or more adjustment modules 140 having one or more second interfaces 115 disposed thereupon. One or more third interfaces 150 can be disposed in, on, or about a display device 190. In one or more embodiments, one or more input modules 110 and one or more adjustment modules 140 can be disposed in any number, frequency or arrangement, in, on, or about a display device 190 by communicatively coupling the one or more second interfaces 115 disposed on the input and/or adjustment modules 110, 140 to the one or more third interfaces 150 disposed on the display device 190. In one or more specific embodiments, the one or more input and/or adjustment modules 110, 140 can bi-directionally communicate with each other and the display device 190 via the one or more third interfaces 150.

The one or more third interfaces 150 can be disposed in, on, about, or otherwise communicatively coupled to a switching matrix 155 disposed in, on, or about the display device 190. The switching matrix 155 can be coupled to one or more processors 170 using one or more bi-directional conduits 160. The one or more processors 170 can, in turn, be coupled to one or more output devices 180, for example a video display such as a cathode ray tube (“CRT”) or liquid crystal display (“LCD”), or an audio display such as a speaker, using one or more bidirectional conduits 175. In one or more embodiments, all or a portion of the one or more third interfaces 150, switching matrix 155, conduits 160 and 175, processor 170, and output device 180 can be fully or partially disposed in, on, or about the display device 190. In one or more embodiments, the display device can include, but is not limited to, a television, video monitor, computer monitor, speaker, other audio/visual output device, or any combination thereof.

One or more first interfaces 105 can be disposed in, on, or about the one or more input modules 110. The one or more first interfaces 105 can include one or more interface types, including, but not limited to, wired, wireless, or any combination thereof. For example, in one or more embodiments, the one or more first interfaces 105 can be a wireless transceiver using IEEE 802.11(b), IEEE 802.11(g), IEEE 802.11(n), Bluetooth®, or cellular wireless protocols (e.g. Global System for Mobile Telecommunications (“GSM”), Code Division Multiple Access (“CDMA”), and the like). In one or more embodiments, the one or more first interfaces 105 can be a wired interface using one or more wired audio, video and/or audio/video (“A/V”) standards including, but not limited to, type-A high definition multimedia interface (“HDMI”) standard, a type-B HDMI standard, a type-C HDMI standard, a coaxial interface (“CATV”) standard, a digital visual interface (“DVI”) standard, a super video (“S-video”) interface (4-pin, 7-pin, or 9-pin) standard, a separated video (“S-video”) interface standard, a component video interface standard, a video graphics array (“VGA”) interface standard, a universal serial bus (“USB”) interface standard, a composite video interface standard or any combination thereof. In one or more embodiments, the first interface 105 can be a male or female plug, using either a proprietary or an industry standard interface configuration. In one or more specific embodiments, for example the illustrative embodiment depicted in FIG. 1, the first interface 105 can include a total of five (5) RCA-type, coaxial, female connectors to accommodate standard, component input, RCA-type plugs: (i) a video luma (“Y”) signal; (ii) a blue video (“Pb”) signal; (iii) a red video (“Pr”) signal; (iv) a left audio signal (“A(L)”); and, (v) a right audio signal (“A(R)”).

The signal (“first signal”) can be supplied to the first interface 105 using one or more formats (the “first format”). For example, the first signal supplied to the first interface 105 can be encoded, encrypted, modulated onto one or more carrier waveforms, or any combination thereof. In one or more embodiments, all or a portion of the first signal can be supplied to the first interface 105 in one or more analog first formats. In one or more embodiments, all or a portion of the first signal can be provided in one or more digital first formats. In one or more embodiments, all or a portion of the first signal can be provided in one or more composite (analog+digital) first formats.

Within the input module 110, the first signal can be processed or otherwise conditioned, converted, demodulated, decrypted, decoded, translated, or any combination thereof, providing a second signal using a fixed, standard, or otherwise predetermined audio format, video format, or combined audio/visual (“A/V”) format (the “second format”). In one or more embodiments, the second format can be independent of the mode of transmission and/or formatting of the first signal.

In one or more embodiments, the second signal 130 can be provided in an analog, digital, or composite (analog+digital) second format. In one or more specific embodiments, one or more analog-to-digital (“ADC”) converters can be disposed in, on, or about the input and/or adjustment module 110, 140. In one or more embodiments, the one or more ADCs disposed in, on or about the input and/or adjustment module 110, 140 can partially or completely convert all or a portion of the analog first signal in the first format to a digital second signal 130 in the second format.

In one or more embodiments, one or more digital-to-digital (“DDC”) converters can be disposed in, on, or about the input and/or adjustment module 110, 140. In one or more embodiments, the one or more DDCs disposed in, on or about the input and/or adjustment module 110, 140 can be used to partially or completely convert all or a portion of the digital first signal to a digital second signal in the second format.

In one or more embodiments, one or more analog-to-digital (“ADC”) converters and/or one or more digital-to-digital (“DDC”) converters can be disposed in, on, or about the input and/or adjustment modules 110, 140. In one or more embodiments, the one or more ADCs and/or DDCs disposed in, on or about the input and/or adjustment module 110, 140 can be used to partially or completely convert all or a portion of the composite first signal in the first format to a digital second signal 130 in the second format. The second signal 130 can be transmitted, transferred, or otherwise communicated from the input and/or adjustment modules 110, 140 to the switching matrix 155 using a second interface 115 disposed in, on, or about the input and/or adjustment modules 110, 140 and one or more bidirectional communications conduits 120.

The one or more second interfaces 115 can include one or more wireless or wired interfaces suitable for bi-directional communication with one or more third interfaces 150. In one or more embodiments, the second interface 115 can be a male or female plug body and the third interface 150 can be a complementary male or female plug body such that the insertion, adjoining, or combining of the second interface 115 with the third interface 150 can couple the input and/or adjustment modules 110, 140 to the display device 190. In one or more specific embodiments, the input and/or adjustment modules 110, 140 can be temporarily or permanently attached to the display device 190 by affixing or otherwise attaching the second interface 115 to the third 150 interface. In one or more embodiments, the second interface 115 disposed on the input module 110 and the second interface disposed on the adjustment module 140 can be interchangeable (i.e. using identical second interfaces and/or identical second format communications protocol). Such replaceable or interchangeable input and/or adjustment modules 110, 140 can be advantageous where the accommodation of a combination of legacy and other audio, video, and/or A/V formats is necessary on a single display device 190. Such temporary or interchangeable input and/or adjustment modules 110, 140 can also be advantageous in permitting the ready adaptation or input of newer audio, video, or A/V formats in existing display devices 190.

In one or more specific embodiments, the one or more adjustment modules 140 can include, but are not limited to, one or more modules suitable for correcting, enhancing, or otherwise adjusting the video signal provided by one or more input modules 110 and/or processors 170. For example, the one or more adjustment modules 140 can include one or more adjustments for color, tone, tint, resolution, sharpness, definition, color temperature, etc. In one or more specific embodiments, the one or more adjustment modules 140 can include, but are not limited to, one or more modules suitable for correcting, enhancing, or otherwise adjusting the audio signal provided by one or more input modules 110 and/or processors 170. For example, the one or more adjustment modules 140 can permit or provide one or more adjustments for noise reduction, multichannel sound, provision of secondary audio programming (“SAP”), provision of one or more surround sound technologies, etc. In one or more specific embodiments, the one or more adjustment modules 140 can include, but are not limited to, one or more modules suitable for correcting, enhancing, or otherwise adjusting either or both the video and audio signals provided by one or more input modules 110 and/or processors 170.

In one or more embodiments, the second signal 130 can be broadcast, transmitted, transferred, or otherwise communicated from the one or more second interfaces 115 to the third interface 150. The communication 120 between the input module 110 and the third interface 150 can be unidirectional or bi-directional based upon the inherent functionality of the input and/or adjustment modules 110, 140 communicatively coupled to the third interface 150. For example, bi-directional communication with the input module 110 can occur when the input module 110 has one or more user-definable adjustment functionality. In one or more specific embodiments, the communication 120 between the adjustment module 140 and the third interface 150 can be unidirectional or bi-directional based upon the functionality of the adjustment module 140.

The one or more third interfaces 150 can include one or more industry-standard or proprietary interface types. In one or more embodiments, the one or more third interfaces 150 can include one or more industry-standard, wired, serial data interfaces, for example one or more IEEE 1394 (“Firewire”), universal serial bus (“USB”), or the like. In one or more embodiments, the one or more third interfaces 150 can include one or more industry-standard, wireless, serial data interfaces, for example one or more IEEE 802.11 interfaces, Bluetooth® interfaces, or the like. In one or more embodiments, the one or more third interfaces 150 can include one or more non-standard, wired, serial and/or parallel, data interfaces. In one or more embodiments, the one or more third interfaces 150 can include one or more non-standard, wireless, serial and/or parallel, data interfaces.

In one or more embodiments, the one or more adjustment modules 140 can be used to adjust, compensate, convert, or otherwise adjust one or more signals bi-directionally communicated to the adjustment module 140 by the switching matrix 155. In one or more embodiments, the signal supplied to the adjustment module 140 via the switching matrix 155 can be the second signal 130, for example the second signal 130 generated by one or more input modules 110. In one or more embodiments, the signal supplied to the adjustment module 140 via the switching matrix 155 can include one or more signals provided by the processor 170, communicated to the switching matrix 155 via the one or more conduits 160. In one or more embodiments, the signal supplied to the adjustment module 140 via the switching matrix 155 can include a composite signal generated by mixing, multiplexing, or otherwise combining one or more signals from one or more input modules 110 and one or more signals from the processor 170.

In one or more embodiments, the switching matrix 155 can permit the unidirectional passage of one or more signals between the one or more input and/or adjustment modules 110, 140 and the processor 170 via the one or more third interfaces 150. In one or more embodiments, the switching matrix 155 can permit the communication 120 of one or more second signals 130 between the one or more input and/or adjustment modules 110, 140 and the processor 170. In one or more embodiments, all or a portion of the power required or otherwise consumed by the input and/or adjustment modules 110, 140 can be provided by the display device 190 via the one or more third interfaces 150.

The second signal 130 from the one or more input and/or adjustment modules 110, 140 can be communicated from the switching matrix 155 to the processor 170 via one or more bi-directional conduits 160. Within the processor 170, the second signal 130 can be filtered, demodulated, decrypted, decoded, or otherwise processed to provide one or more audio and/or video signals via conduit 175. The one or more processors 170 can include, but are not limited to, one or more components, devices, systems or combination of components, systems and/or devices to further enhance, define, filter or otherwise adjust the quality of the audio, video, and/or A/V signals provided by the one or more conduits 160. In one or more embodiments, the one or more processors 170 can include one or more chipsets disposed in, on, or about one or more mother and/or daughter boards. Exemplary components, devices, and/or systems disposed in, on, or about the one or more processors 170 can include one or more three dimensional comb filters, for example to separate the luminance/brightness and chrominance/color information contained in the second signal 130; and one or more chroma decoders to decode the color signal into a red/green/blue (“RGB”) signal suitable for displaying color images on the output device 180. In one or more embodiments, the processor 170 can include one or more upconverters to improve the video quality of the first signal, for example to upconvert a 480i second signal 130 to a 1080i signal for display on the display device 180. In one or more embodiments, the processor 170 can include one or more memory registers for the storage of module data collected from one or more modules attached to the switching matrix 155 via the one or more third interfaces 150.

In one or more embodiments, all or a portion of the one or more audio, video, or A/V signals provided by the processor 170 via the one or more conduits 175 can be broadcast or otherwise displayed on the output device 180 that can be partially or completely disposed within the display device 190.

With reference to the exemplary system depicted in FIG. 1, in operation, a component video and dual-channel audio first signal can be introduced to the input module 110 via the one or more first interfaces 105. Within the input module 110, the first signal can be converted to a second signal 130 having a predetermined second format. The second signal 130 can be bi-directionally communicated 120 via the second interface 115 and third interface 150 to the switching matrix 155.

Within the switching matrix 155, the second signal 130 can be communicated or otherwise transmitted, in whole or in part, to the processor 170 and/or one or more adjustment modules 140. In one or more embodiments, at least a portion of the second signal 130 can be communicated from the input module 110 to the processor 170 via the switching matrix 155. In one or more embodiments, at least a portion of the second signal 130 can be communicated from the input module 110 to one or more adjustment modules 140 via the switching matrix 155. In one or more embodiments, the portion of the second signal 130 communicated to the one or more adjustment modules 140 can be communicated to the processor 170 via the switching matrix 155. For example, the audio portion of the second signal 130 provided by the input module 110 can be communicated to the processor 170 via the switching matrix 155, while the video portion of the second signal 130 can be communicated to one or more adjustment modules 140.

The one or more audio signals communicated from the input module 110 to the processor 170 can be filtered, demodulated, decrypted, decoded, or otherwise processed to provide one or more audio signals to the output device 180 via conduit 175. In similar fashion, the one or more video signals communicated from the adjustment module 140 to the processor 170 can be filtered, demodulated, decrypted, decoded, or otherwise processed to provide one or more video signals to the output device 180 via conduit 175.

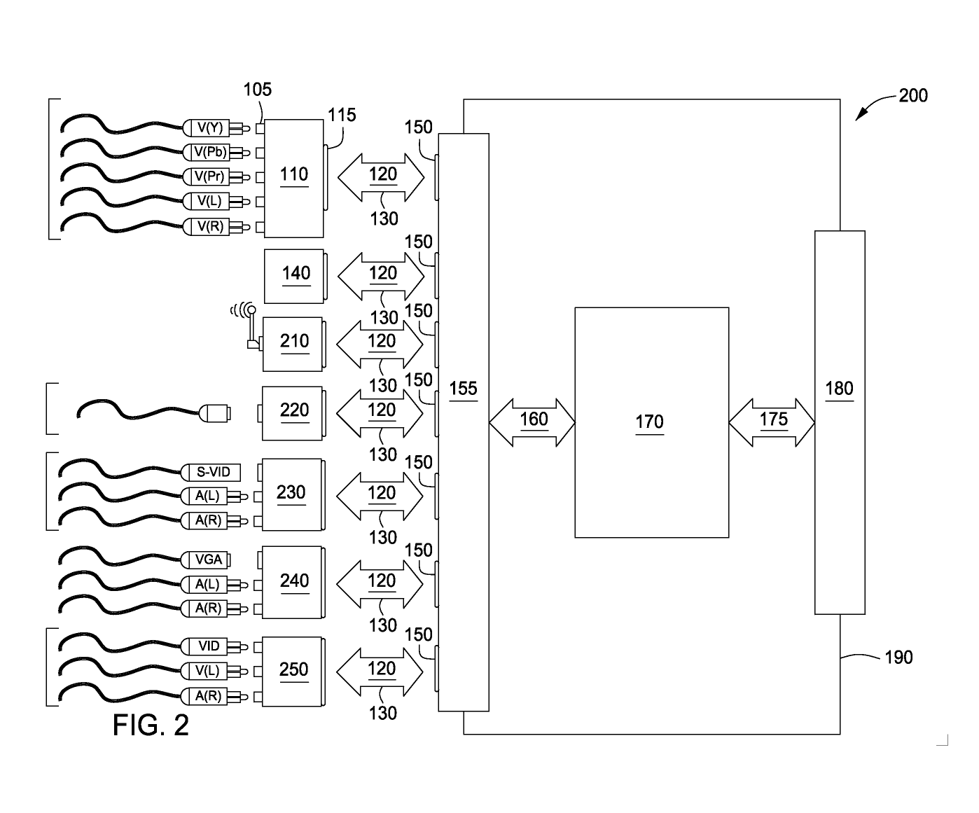

FIG. 2 depicts a schematic diagram of another illustrative modular input system 200, according to one or more embodiments. In one or more embodiments, one or more input modules (six are depicted in FIGS. 2, 110, 210, 220, 230, 240, and 250) and one or more adjustment modules (one is depicted in FIG. 2, 140) can be communicatively coupled 120 to the one or more third interfaces 150. Such an assortment of input and/or adjustment modules 110, 140 can provide flexibility to accommodate one or more legacy devices, one or more contemporary devices, and/or one or more future devices in a single display device 190.

The one or more input modules 110, 210, 220, 230, 240, and 250 can be selected from a variety of modules adapted to the reception, conversion, and/or transmission one or more legacy, contemporary or future wired or wireless first signals. In one or more embodiments, the one or more converter modules can include one or more modules adapted to receive, convert and/or transmit a wireless first signal via a wireless input module 110. In one or more embodiments, one or more input modules 220 can be adapted to receive, convert, and/or transmit an HDMI compatible first signal. In one or more embodiments, one or more input modules 230 can be adapted to receive, convert, and/or transmit an S-Video compatible first signal. In one or more embodiments, one or more input modules 240 can be adapted to receive, convert, and/or transmit a VGA compatible first signal. In one or more embodiments, one or more input modules 250 can be adapted to receive, convert, and/or transmit composite video and audio signals. In one or more embodiments, the installation of a plurality of input modules 110 can accommodate or otherwise accept a variety of legacy, contemporary or future audio, video, and/or A/V inputs to the display device 190.

In one or more embodiments, when multiple input modules 110, for example the six input modules 110, 210, 220, 230, 240, and 250 depicted in FIG. 2, are communicatively coupled to the switching matrix 155, a user can select the desired input module based upon the availability or presence of one or more wired and/or wireless first signals. In one or more embodiments, the user can select the desired input module 110, 210, 220, 230, 240, and/or 250 via an on screen menu system communicated to the user by the output device 180, for example a menu driven selection system commonly found on television sets and/or computer monitors. When one or more adjustment modules 140 are also communicatively coupled to the switching matrix 155, the options provided by the adjustment module 140 can be similarly communicated to the user via the output device 180. The processor 170 can incorporate one or more user selected adjustment options by communicating or otherwise transmitting all or a portion of the second signal 130 provided from one or more input modules 110, 210, 220, 230, 240, and 250 and/or processor 170 through the one or more adjustment modules 140 communicatively coupled to the switching matrix 155.

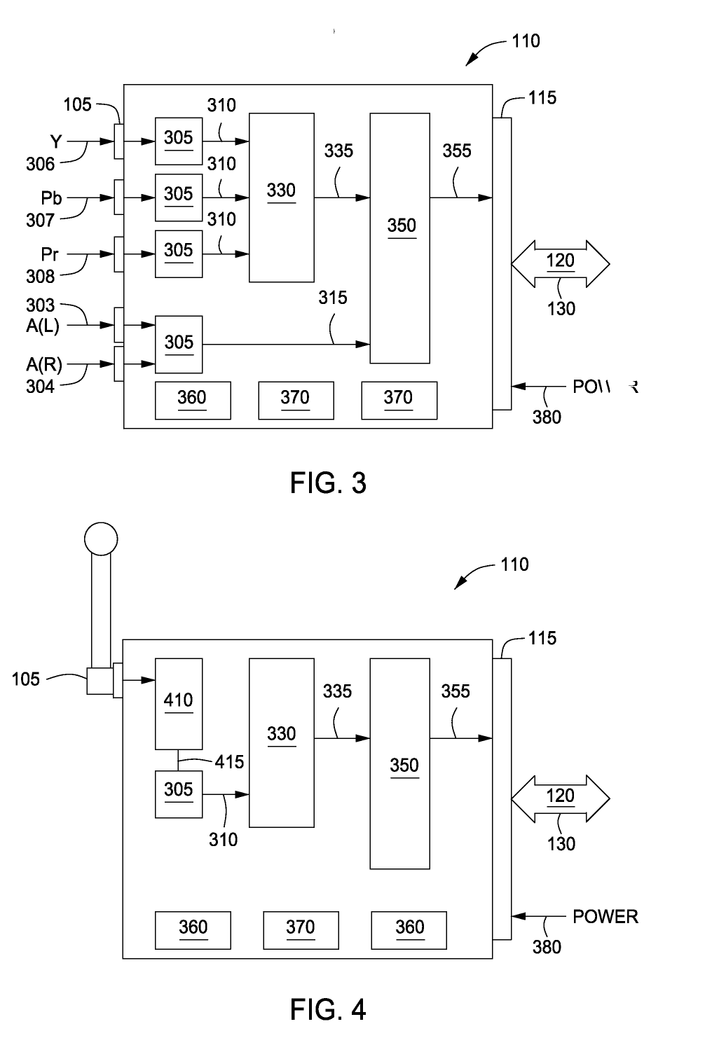

FIG. 3 depicts an exemplary wired input module 110, according to one or more embodiments. For clarity and ease of understanding, a wired converter module using a component video signal input shall be herein described in detail. As should be readily apparent to one of ordinary skill in the signal processing arts, the operating principles and structures herein described with reference to a component video input module 110 can be readily translated, converted, and/or transferred to one or more other similar wired input modules 110, including but not limited to, an HDMI input module 220, an S-video input module 230, a VGA input module 240, and/or a composite video input module 250.

In one or more embodiments, the exemplary component video input module 110 depicted in FIG. 3 can include one or more converters 305. For example, the component video input module 110, as depicted in FIG. 3, can contain one or more analog-to-digital converters (“ADCs”) 305. As depicted in FIG. 3, a total of four ADCs 305 can be disposed in, on, or about the input module 110: one ADC 305 for each video signal (Y, Pb, Pr, for a total of three ADCs) and a single ADC 305 for both audio channels (left and right, for a total of one ADC). In addition to the four ADCs, a pre-processor 330, and a signal packet processor 350 can be disposed in, on, or about the component video input module 110. In one or more embodiments, one or more of the three video processing ADCs 305 can be a high-definition ADC. In one or more embodiments, the component video input module 110 can include one or more identification ROMs (“ID ROMs”) 360, two identical ID ROMs 360 are disposed in the component video input module 110 depicted in FIG. 3. Finally, one or more timing processors 370 can be disposed in the component video input module 110. In one or more embodiments, the timing processor 370 can be used to synchronize or otherwise temporally coordinate the first signal with the second signal 130.

The first signal, having a component video and audio first format, can be introduced to the one or more ADCs 305 via the first interface 105. In one or more embodiments, the first signal provided to the first interface 105 can be generated or otherwise supplied by any type of audio, video, and/or A/V signal generator including, but not limited to, a computer graphics processor, a cable television receiver, a satellite television receiver, a video recording device or the like. The first signal can be supplied to the first interface 105 in a first format, for example a three-component, analog, Y/Pb/Pr video signal format combined with independent analog left and right audio signals. In one or more embodiments, each of the Y (luma) signal 306, Pb (chrome-blue) signal 307, and Pr (chrome-red) signal 308 can be supplied using three independent cables terminated with a male RCA-type connector on one or more ends. In one or more embodiments, a left audio channel signal 203 and a right audio channel signal 304 can be supplied using two independent cables terminated using male RCA-type connectors on one or more ends. In one or more specific embodiments, the first interface 105 disposed in, on, or about the component video input module 110 can include five complementary RCA-type female connectors (three connectors for the video signals Y/Pb/Pr, 306, 307, and 308 and two connectors for the audio signals, 303 and 304). In a like manner similar male/female plug and first interface 105 combinations can be similarly disposed in, on or about the component video input module 110 to accommodate current and future signal and/or cable formats and/or standards.

The one or more first signals provided to the one or more first interfaces 105 can be introduced, transmitted, or otherwise transferred to one or more converters 305. In one or more embodiments, two or more components forming all or a portion of the audio, video, and/or A/V portions of the first signal can be provided to a single converter 305, for example, the left and right audio channels can be introduced, transmitted, or otherwise transferred to a single converter 305 as depicted in FIG. 3. In one or more embodiments, the individual components forming all or a portion of the first signal can be individually introduced, transmitted, or otherwise transferred to one or more independent converters 305, for example the Y, Pb, and Pr video first signals as depicted in FIG. 3.

The one or more converters 305 can include one or more digital-to-digital (“DDC”) converters, one or more analog-to-digital (“ADC”) converters, or any combination thereof. The choice or selection of the one or more converters 305 can be dependent upon the format of the first signal. Where the first signal uses one or more analog formats including, but not limited to component video format, composite video format, analog audio, S-video format, and/or VGA format, one or more ADC converters 305 can be disposed in, on or about the input module 110. Where the first signal uses one or more digital formats including, but not limited to HDMI format, and/or DVI format, one or more DDC converters 305 can be disposed in, on, or about the input module 110. Where the first signal uses one or more composite (analog+digital) formats, one or more ADC converters 305 and/or DDC converters 305 can be disposed in, on or about the input module 110.

In one or more embodiments, the one or more converters 305 can include one or more linear electronic ADC converters, non-linear electronic ADC converters, or any combination thereof. Any type of electronic ADC converter can be used including, but not limited to, direct conversion or flash ADC converter, successive-approximation ADC converter, ramp-compare ADC converter, delta-encoded ADC converter, pipeline ADC converter, Sigma-Delta ADC converter, delay-line ADC converter, or any combination thereof. The one or more ADCs 305 can have any resolution suitable for the digital conversion of one or more analog audio, video, or A/V signals. For example, an illustrative ADC 305 can operate at a sampling rate of from about 4 bits to about 24 bits. The ADC can operate at any sampling rate suitable for the digital conversion of one or more analog audio, video, or A/V signals. For example an illustrative ADC converter 305 can have a minimum sampling rate of 10-megasamples-per-second to a maximum sampling rate of 350-megasamples-per-second.

The digital signal provided by the one or more converters 305 can be introduced, transmitted, or otherwise transferred via one or more conduits 310 to one or more processors 330. The one or more processors 330 can collect the one or more digital signals provided by the one or more converters 305 and convert the one or more independent signals into a single, unified, color space and format signal. This signal can be introduced, transmitted, or otherwise transferred via one or more conduits 335 to one or more transmitters 350. Any additional digital signals, for example the digital signal resulting from the analog-to-digital conversion of the left and right analog audio channels, can also be introduced via one or more conduits 315 to the one or more transmitters 350.

The one or more digital signals provided to the transmitter 350 via the conduits 315 and/or 335 can be packetized within the transmitter 350. In one or more embodiments, the one or more digital signals provided to the transmitter 350 via the conduits 315 and/or 335 can be multiplexed within the transmitter 350 using one or more multiplexing techniques including, but not limited to space division multiplexing, frequency division multiplexing, time division multiplexing, or any combination thereof. In one or more embodiments, the video signal supplied via the conduit 335 and audio signal supplied via the conduit 315 can be separately packetized thereby forming two or more independent, packetized, audio and video signals using one or more predetermined second formats. In one or more embodiments, video signal supplied via the conduit 335 and audio signal supplied via the conduit 315 can be packetized and combined, thereby forming a composite second signal 130 containing both audio and video data, in a predetermined second format. Thus, while the first signal provided to the input module 110 can vary dependent upon the source of the signal, the second, packetized, signal provided by the transmitter 350 can be in a uniform second format regardless of the source and/or format of the first signal.

In one or more embodiments, one or more identification read-only memory (“ID-ROM”) devices 360 can be disposed in, on, or about the input module 110 to uniquely identify the type of audio, video, and/or A/V first signals inputted to the module via the first interface 105. In one or more embodiments, the one or more ID-ROMs 360 can contain one or more parameters characterizing the second signal 130 transmitted by the input module 110 to the display device 190. Such parameters can include, but are not limited to, color, tint, resolution, pixel size, chrome, luminosity, refresh rate, or any combination thereof. In one or more embodiments, all or a portion of the data contained in the ID-ROM 360 can be multiplexed with the audio, video, and/or A/V data and transferred to the display device 190 via the one or more conduits 355. In one or more embodiments, all or a portion of the data contained in the ID-ROM 360 can be transferred to the display device 190 independent of the multiplexed audio, video, and/or A/V data transferred to the display device 190 via the one or more conduits 355.

In one or more embodiments, the one or more timing processors 370 can be disposed in, on, or about the input module 110 to synchronize, sequence, or otherwise ensure consistent timing between the first signal and the second signal 130. In one or more embodiments the one or more timing processors 370 can include, but is not limited to, one or more phase-lock loop (“PLL”) devices. In one or more embodiments, the timing processors 370 can include a PLL that generates one or more clocking signals using an approximate frequency reference, and then phase-aligns to the transitions in the first signal with the PLL.

In one or more embodiments, power can be supplied to the one or more input modules 110 from the display device 190 via one or more conductors 380. In one or more embodiments, the power supplied via the one or more conductors 380 can be at any voltage and/or current. In one or more embodiments, the power supplied via the one or more conductors can be AC, DC, or AC/DC composite voltage. In one or more embodiments, the one or more conductors 380 can be integrated or otherwise incorporated into the third interface 150. In one or more embodiments, the one or more conductors 380 can be independent of the third interface 150. In one or more embodiments the power supplied to the input module 110 via the one or more conductors 380 can be an AC voltage of from about 5 VAC to about 230 VAC; about 10 VAC to about 150 VAC; or about 20 VAC to about 120 VAC; supplied at a frequency of from about 30 Hz to about 120 Hz; about 45 Hz to about 75 Hz; or about 50 Hz to about 70 Hz, In one or more embodiments, the power supplied to the input module 110 via the one or more conductors 380 can be a DC voltage of from about 3 VDC to about 24 VDC.

FIG. 4 depicts an exemplary wireless input module 110, according to one or more embodiments. In one or more embodiments, the first interface 105 can include one or more wireless interlaces including, but not limited to, one or more IEEE 802.11 compliant wireless devices, one or more Bluetooth® wireless devices, one or more cellular devices, or the like. In one or more embodiments, the one or more wireless interfaces 105 can be coupled to one or more wireless transceivers 410. The one or more wireless transceivers 410 can be suitable for the transmission and reception of one or more data and/or control signals with one or more remote signal generators having authenticated or otherwise suitable credentials and operating within the frequency spectrum of the transceiver 410.

In one or more embodiments, the first signal can be introduced, transmitted, or otherwise transferred from the transceiver 410 to one or more converters 305 via one or more conduits 415. Similar to the wired module described in detail with respect to FIG. 3, the one or more converters 305 can include one or more digital-to-digital (“DDC”) converters, one or more analog-to-digital (“ADC”) converters, or any combination thereof. The selection of the one or more converters 305 can be dependent upon the first signal format.

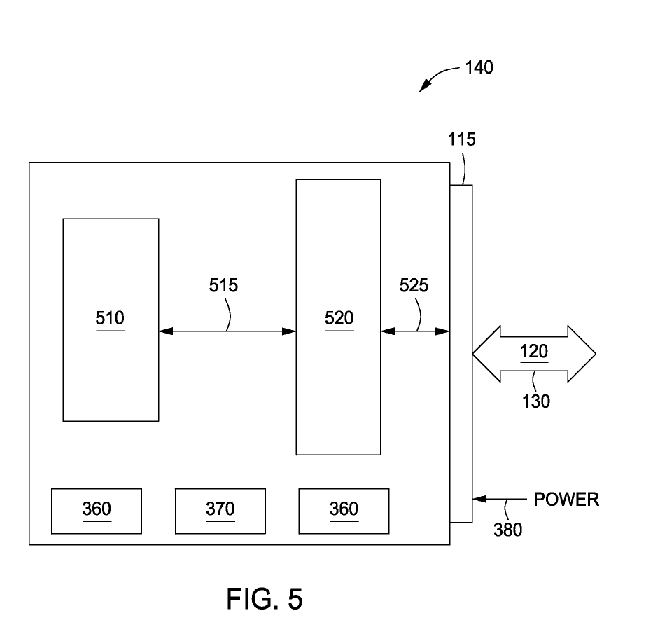

FIG. 5 depicts an exemplary adjustment module 140, according to one or more embodiments. In one or more embodiments, the adjustment module can include, but is not limited to, one or more processors 510, one or more transceivers 520, and one or more bidirectional conduits (two are depicted in FIGS. 5, 515 and 525). The exemplary adjustment module 140 depicted in FIG. 5 can include, but is not limited to, any module suitable for altering, affecting, correcting, or otherwise adjusting one or more audio signals, one or more video signals, and/or one or more A/V signals communicated or otherwise transmitted to the adjustment module 140 via the switching matrix 155. In one or more specific embodiments, the one or more adjustment modules 140 can include one or more audio adjustments, for example digital noise reduction, Dolby® noise reduction, equalization, tonal adjustment, secondary audio processing, or the like. In one or more specific embodiments, the one or more adjustment modules 140 can include one or more video adjustments, for example digital noise reduction, color compensation, colorization of black & white images, resolution enhancement, upgrading or downgrading of signal content or quality to match the capabilities of the output device 180, or the like. In one or more specific embodiments, the one or more adjustment modules 140 can include both audio and video adjustments.

In one or more embodiments, one or more operational parameters of the adjustment module 140 can be accessed by the user via one or more menus displayed on the output device 180 of the display device 190. In one or more embodiments, such adjustments can be effected by the user via handheld remote, touchscreen, or the like. In one or more embodiments, one or more user inputted commands can be received by the processor 170 disposed within the display device 190 and transmitted to the adjustment module 140 via the switching matrix 155 and the one or more bidirectional conduits 525.

In one or more embodiments, one or more signals can be introduced to the adjustment module 140 via the one or more second interfaces 115. The switching matrix 155 can transfer the one or more signals to the transceiver 520 via the second interface 115 and the one or more bidirectional conduits 525. The signal can be transferred from the transceiver 520 to the processor 510 via the one or more bidirectional conduits 515. Within the processor 510, the signal can be adjusted based upon one or more predetermined instructions, one or more user-entered instructions, or any combination thereof. The modified signal can be transmitted from the processor 510 to the one or more transceivers 520 and thence to the switching matrix 155.

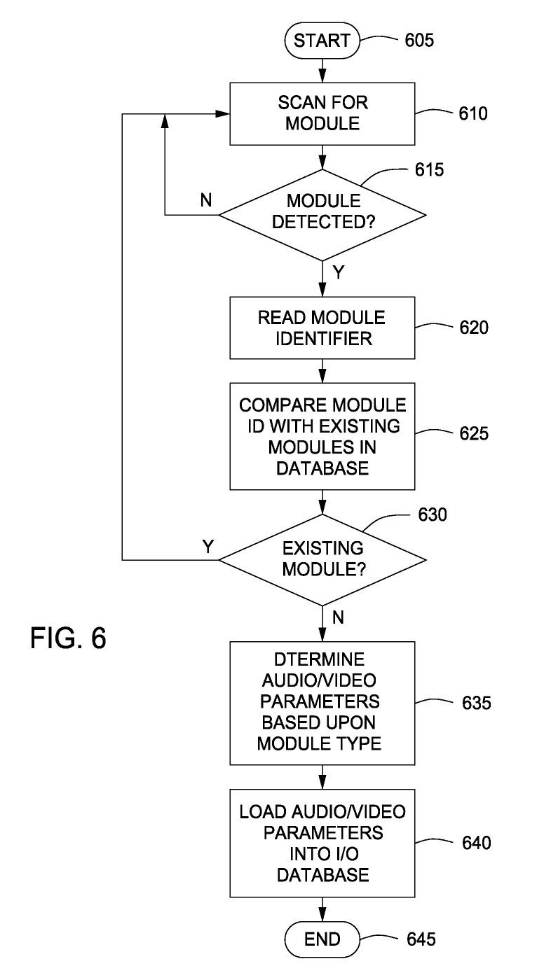

FIG. 6 depicts an exemplary logic flow diagram for communicating one or more audio, video, and/or A/V signals to a display device 190 using one or more input and/or adjustment modules 110, 140, according to one or more embodiments. In step 610 the processor 170 can scan all or a portion of the third interfaces 150 to detect the presence of one or more input and/or adjustment modules 110, 140. In one or more embodiments, the scan can be performed upon the initial application of power to (i.e. powering-up), or resetting the power supply to, the display device 190. In one or more embodiments, the scan can be performed on a regular or irregular time or temporal basis while power is supplied to the display device 190. In one or more embodiments, the processor 170 can periodically or continuously execute one or more automatic detection routines to automatically detect the insertion of one or more converter or adjustment input modules 110, 140.

If, the display device 190 does not detect one or more input and/or adjustment modules 110, 140 in step 615, control can be returned to the scan routine in step 610. If one or more input and/or adjustment modules 110, 140 are detected in step 415, the processor 330 can read the ID-ROM 370 of the input and/or adjustment modules 110, 140. After reading the ID-ROM 370, the processor 330 can compare the ID-ROM 360 disposed in, on, or about the input and/or adjustment modules 110, 140 with one or more stored databases containing one or more records of previously installed ID-ROMs 360. If the processor 170 determines in step 625 that all of the detected input and/or adjustment modules 110, 140 were previously installed, control can be returned to step 610.

If the processor determines in step 625 that the detected converter or adjustment input module 110, 140 was not previously installed, i.e. that the detected module is newly inserted, the processor 170 can poll the ID-ROM 360 of the converter or adjustment input module 110, 140 to ascertain or otherwise determine the identification and one or more specific operating parameters of the converter or adjustment input module 110, 140. Such parameters may include, but are not limited to, color palette, tint parameters, maximum signal resolution, maximum or minimum signal pixel size, chroma, luminosity, refresh rate, or any combination thereof. In one or more embodiments, the module identification and operating parameters can be loaded into one or more volatile or non-volatile memory registers disposed in, on, or about the display device 190. In one or more embodiments, the module identification and operating parameters can be loaded into one or more nonvolatile memory registers disposed in, on, or about the processor 170.

The control logic herein described can be implemented in software, hardware, or any combination thereof. In one or more embodiments, the control logic can be implemented in hardware, including, but not limited to, a programmable logic device (PLD), programmable gate array (PGA), field programmable gate array (FPGA), an application-specific integrated circuit (ASIC), a system on chip (SoC), and a system in package (SiP).

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A modular signal interface system, comprising:
an input module 110 comprising:
one or more first interfaces 105 configured to accept one or more first signals having a first format;
a converter 305 to convert the one or more first signals from the first format to one or more second signals 130 having a predetermined second format; and
a second interface 115 configured to bi-directionally communicate the one or more second signals 130; and
a display device 190 comprising an output device 180 and a bi-directional third interface 150 having at least one input module 110 detachably attached thereto, wherein at least a portion of the second interface 115 is communicatively coupled to at least a portion of the bi-directional third interface 150.

2. The system of claim 1, further comprising one or more identification ROMs 360 disposed within the input module 110 wherein the one or more identification ROMs transmit one or more module data signals via the second interface 115 to the display device 190.

3. The system of claim 1, further comprising one or more timing processors 370 disposed within the input module 110, wherein the one or more timing processors 370 synchronize the one or more first signals and the one or more second signals 130.

4. The system of claim 1 wherein the output device 180 is selected from the group consisting of: a CRT display, a plasma display, a liquid crystal display (“LCD”), a liquid crystal on silicon (“LCoS”) display, a direct projection display, an indirect projection display, an organic light emitting diode (“OLED”) display, and a digital light processing (“DLP®”) display.

5. The system of claim 1, further comprising one or more adjustment modules 140 communicatively coupled to one or more bi-directional third interfaces, each adjustment module 140 comprising:
one or more bi-directional second interfaces 115;
one or more processors 510; and
one or more transceivers 520.

6. The system of claim 5, wherein the one or more processors 510 can adjust one or more audio, video, or audio/video components selected from the group consisting of: audio noise reduction, video noise reduction, audio equalization, audio tonal adjustment, secondary audio programming, video color compensation, colorization of black and white video images, video resolution enhancement, and video resolution degradation.

7. The system of claim 1 wherein the first interface 105 is selected from the group consisting of: a type-A high definition multimedia interface (“HDMI”), a type-B HDMI, a type-C HDMI, a coaxial interface, a digital visual interface (“DVI”), a super video (“S-video”) interface, a separated video (“S-video”) interface, a component video interface, a video graphics array (“VGA”) interface, a universal serial bus (“USB”) interface, and a composite video interface.

8. A method for transferring a signal to a display device 190 via an input module 110, comprising:
detachably attaching an input module 110 to a display device 190, the input module 110 comprising:
one or more first interfaces 105;
a converter 305; and
a bi-directional second interface 115;
introducing a first signal in a first signal format to the one or more first interfaces 105;
converting all or a portion of the first signal from the first signal format to a second signal 130 having a predetermined second signal format;
transmitting all or a portion of the second signal 130 from the second interface 115;
receiving all or a portion of the second signal 130 using a bi-directional third interface 150 disposed in, on, or about the display device 190.

9. The method of claim 8, further comprising:
transmitting first signal identification information from the input module 110 to the display device 190 via an identification ROM 360 communicating to the display device 190 the second interface 115;
receiving the first signal identification information into the display device 190 via the third interface 150; and
adjusting one or more display parameters of the display device 190 based upon the first signal identification information provided to the display device 190 by the identification ROM 360.

10. The method of claim 8, further comprising synchronizing the first signal and the second signal 130 using one or more timing processors 370 disposed within the converter input module 110.

11. The method of claim 8, wherein the second interface 115 comprises a wireless transmitter and the third interface 150 comprises a wireless receiver.

12. The method of claim 8, wherein the second interface 115 comprises one or more contacts and the third interface 150 comprises one or more complimentary contacts.

13. The method of claim 9, wherein the one or more display parameters comprise color, tint, resolution, pixel size, chrome, luminosity, refresh rate, or any combination thereof.

14. A modular signal interface apparatus, comprising:
at least one input module 110 comprising:
one or more first interfaces 105 configured to accept one or more first signals having a first format;
a converter 305 to convert the one or more first signals from the first format to one or more second signals 130 having a predetermined second format; and
a second interface 115 configured to bi-directionally communicate the one or more second signals 130;
a display device 190 comprising;
an output device 180;
one or more processors 170, wherein the one or more processors are selected from a group consisting of: a three-dimensional comb filter, a chroma decoder, and an upconverter;
a plurality of bi-directional third interfaces 150, at least one of the plurality of bi-directional third interfaces 150 having at least one input module 110 detachably attached thereto, wherein at least a portion of the second interface 115 is communicatively coupled to at least a portion of the bi-directional third interface 150;
a switching matrix 155 communicatively coupled to all or a portion of the plurality of bi-directional third interfaces 150 and communicatively coupled to one or more processors 170.

15. The apparatus of claim 14, further comprising one or more adjustment modules 140 communicatively coupled to one or more bi-directional third interfaces 150, each adjustment module 140 comprising:
one or more bi-directional second interfaces 115; and
one or more processors 510 wherein the one or more processors 510 can adjust one or more audio, video, or audio/video components selected from the group consisting of; audio noise reduction, video noise reduction, audio equalization, audio tonal adjustment, secondary audio programming, video color compensation, colorization of black and white video images, video resolution enhancement, and video resolution degradation.
